(19) United States
(12) Patent Application Publication
(10) Pub. No.: US 2004/0135376 A1
(43) Pub. Date: Jul. 15, 2004

(54) Flush bolt

(76) Inventor: Mark Jeffries, Cumming, GA (US)

Correspondence Address: POLSINELLI SHALTON & WELTE, P.C., 700 W. 47TH STREET, SUITE 1000, KANSAS CITY, MO, 64112-1802, US

(21) Appl. No.: 10/752,878

(22) Filed: Jan. 7, 2004

Related U.S. Application Data
(60) Provisional application No. 60/439,241, filed on Jan. 10, 2003.

(51) Int. Cl. E05C 1/04

(52) U.S. Cl. 292/147

(57) ABSTRACT

A latching device, such as a flush bolt, includes a housing having at least one detent, a bolt configured for sliding at least partially within the housing between a retracted position and an extended position, where the bolt extends beyond the housing, and a spring member. The spring member is in communication with the bolt. The spring member is configured for retaining the bolt in a frictionally snug and slideable engagement within the housing and includes a portion configured for engaging the at least one detent of the housing to retain the bolt in the retracted or extended positions, until the requisite engagements are broken by manual force.

### CROSS-REFERENCES TO RELATED APPLICATIONS

This application is related to and claims priority from U.S. Provisional Patent Application, Serial No. 60/439,241, entitled: FLUSH BOLT, filed on Jan. 10, 2003. U.S. Provisional Patent Application Serial No. 60/439,241 is incorporated by reference herein.

### TECHNICAL FIELD

The present invention relates to latching devices, such as flush bolts, and systems for their use.

### BACKGROUND

Flush bolts typically are formed of a sliding screw bolt whose head is countersunk, so as to be flush with a surface. These flush bolts are typically on the outer portions of a door, but are not placed along the door surface that faces another door surface or the doorjamb. This is because these flush bolts are typically of large constructions. Additionally, these large constructions typically create realtively weak engagements, such that the bolts slide out of their engagements, or can be forcibly broken from their engagements, resulting in the doors, to which the flush bolts are attached, sliding out of their closed positions.

### SUMMARY

The present invention is directed to a latching device, such as a flush bolt and system associated therewith, that can be mounted on a door surface adjacent another door surface or door jamb, or on a surface such that it is substantially flush with an outer face or an outer edge of a door. One embodiment of a flush bolt includes a housing formed of a closed extrusion that encloses a unitary bolt. The bolt slides linearly within this housing to move between retracted (inward) and extended (outward) positions, allowing for a door, for example, on which the flush bolt is attached, to be locked and unlocked as desired.

The flush bolt of the present invention is stronger than conventional flush bolts, and easier to move between bolt extended and retracted positions. It also is of fewer moving parts, and is of a simple construction. Its construction can allow it to be inter-locked into doors, such as in an integrated door cut out, without the need for fasteners.

An embodiment of a latching device includes a housing, a bolt configured for sliding at least partially within the housing between a retracted position, where the bolt is substantially within the housing, and an extended position, where the bolt extends beyond the housing. There is also a spring member in communication with the bolt. The spring member is configured for retaining the bolt in a frictionally snug and slideable engagement within the housing and includes a flexible portion (member) configured for engaging at least one structure within the housing. This portion retains the bolt in the extended position, until it is moved, typically by being deflected, out of this engagement by manual force.

Another embodiment is directed to a latching device having a housing including at least one detent and a bolt configured for sliding at least partially within the housing between a retracted position and an extended position, where said bolt extends beyond the housing. There is also a spring member in communication with the bolt, the spring member configured for at least partially retaining the bolt in a frictionally snug and slideable engagement within the housing and limiting travel of the bolt by engaging the at least one detent. The housing at least partially envelops the bolt.

### BRIEF DESCRIPTION OF THE DRAWINGS

Attention is now directed to the drawings, where like numerals and characters indicate like or corresponding components. In the drawings:

FIG. 1A is a perspective view of an embodiment of the flush bolt in a first or retracted position;

FIG. 1B is a perspective view of the embodiment of FIG. 1A in a second or extended position;

FIG. 2 is a cross-sectional view of the flush bolt taken along line 2-2 of FIG. 1A;

FIG. 3 is a cross-sectional view of the bolt taken along line 3-3 of FIG. 1A;

FIG. 4 is a top perspective view of the bolt;

FIG. 5 is a cross sectional view of the spring member, trailer and tab as attached to the bolt of the embodiment of FIGS. 1A and 1B, with the housing removed;

FIG. 6 is a bottom view of the bolt, spring member and trailer of FIG. 2, with the housing removed; and

FIGS. 7A and 7B are perspective views of the flush bolts of FIGS. 1A and 1B in use within a section of a door extrusion.

### DETAILED DESCRIPTION OF THE DRAWINGS

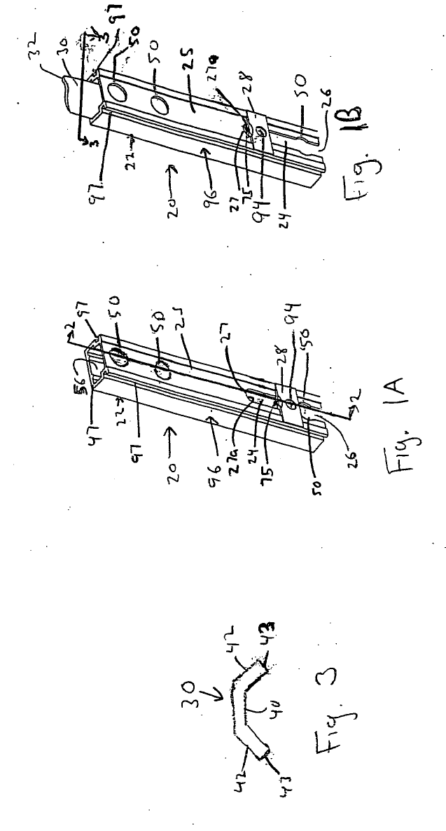

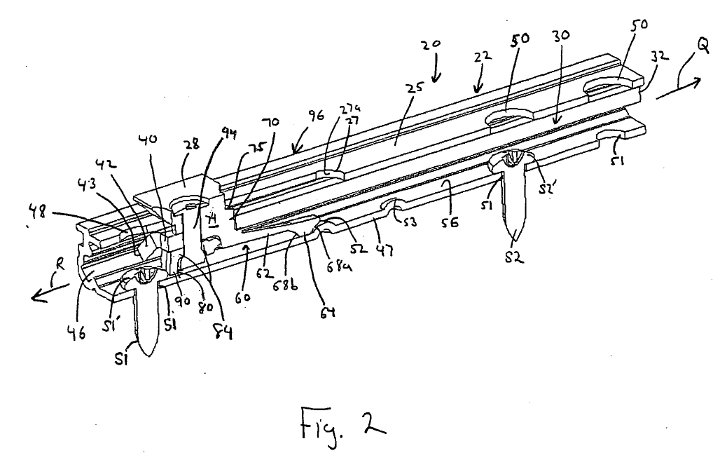

FIGS. 1A and 1B show a first embodiment of the latching device or flush bolt 20. The flush bolt 20 includes a housing 22 having a slot 24 on a first side 25, with open 26 and closed ends 27. A tab 28 is coupled to a bolt 30, slides within the slot 24 (in the directions of arrows Q and R- FIG. 2), allowing for movement, i.e., sliding, of the bolt 30 (in the housing 22), between a first or retracted position and a second or extended position.

In this first or retracted position, the bolt 30, is typically within the housing 22, as shown in FIG. 1A. In this first or retracted position, the tab 28, coupled to the bolt 30, that slides within the slot 24. The tab 28 is at least proximate to the open end 26 of the slot 24. In the second or extended position, where the maximum extension of the bolt 30 has typically occurred, as shown in FIG. 1B, the tab 28 has been slid (in the direction of the arrow Q) such that a tongue 75, of the neck portion 70 supporting the tab 28, abuts the edge 27a of the closed end 27 of the slot 24 (as shown in FIG. 2). The bolt 30 is typically of a length such that when in the first or retracted position, its leading edge 32 is fully within the housing 22, and when in the second or extended position, a portion thereof, including the leading edge 32 extends beyond the housing 22.

Turning also to FIGS. 2-4, there is detailed the internal structure of the flush bolt 20. The housing 22 accommodates the bolt 30 in a slidable engagement. The bolt 30 includes a central portion 40 and lateral portions 42, typically bent so as to define a V-like shape. The edges 43 of the lateral (bent) portions 42 fit within grooves 46 on a second side 47 (opposite the first side 25) of the housing 22. The bolt 30 also includes an opening 48 for accommodating an integral member 74 (formed of the tab 28, spring member 60 and neck portion 70, as detailed below).

The housing 22 also includes openings 50, typically sized to accommodate heads S1′, S2′ and the shanks of the respective screws S1, S2 (added by a user upon mounting the flush bolt 20 to a structure) on the first side 25, with correspondingly aligned openings 51, for accommodating shanks of screws S1, S2, on the second side 47. The second side 47 also includes detents, for example, first 52 and second 53 protrusions, along the surface 56 of the second side 47. These protrusions (detents) 52, 53 can be, for example, spherical, mound-like in shape, and have a rounded or circular base. However, other shapes and configurations for the protrusions (detents) are also suitable provided they can create a sufficient engagement with the tip 64 of the spring member 60 (as detailed below).

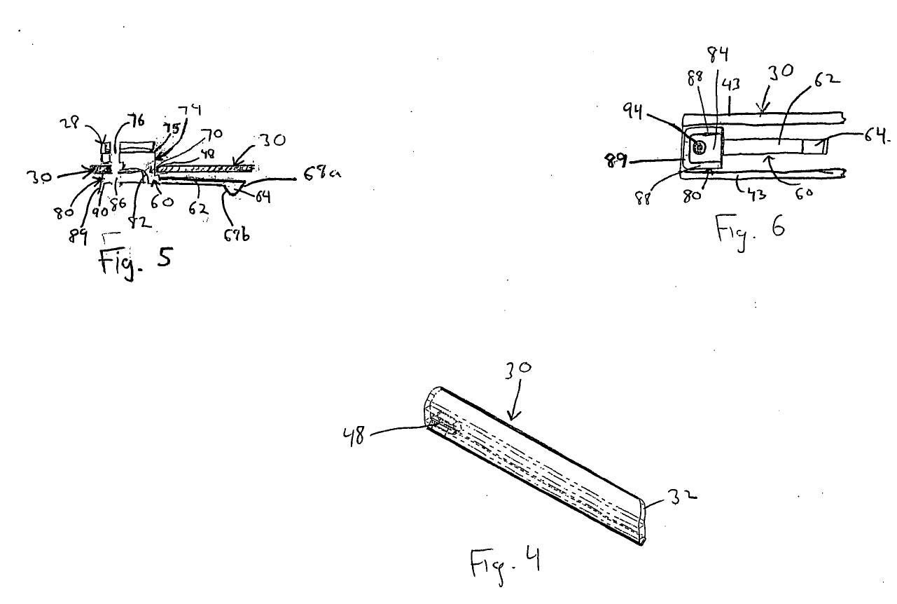

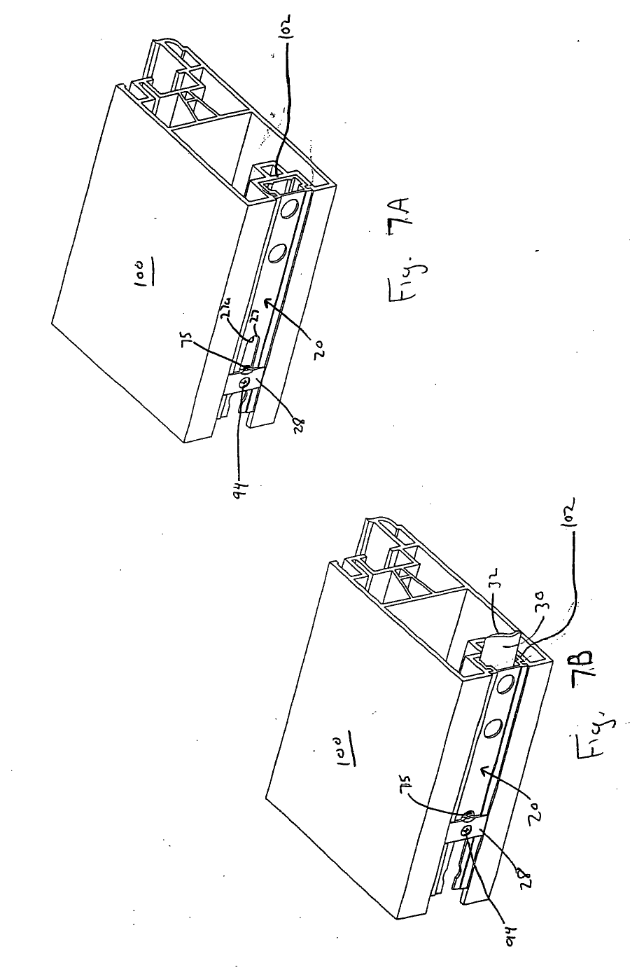

Turning also to FIGS. 5 and 6, the spring member 60 includes an arm 62 with a tip (flange) 64 protruding therefrom. The arm 62 is typically positioned such that the tip 64 contacts, or is just slightly above, the surface 56 of the second side 47, to contact the protrusions 52, 53. For example, the arm 62 may be bent or curved toward the surface 56 of the second side 47 of the housing 22.

The tip 64 typically includes oppositely disposed inwardly (towards each other in a direction away from the arm 62) tapered edges 68a, 68b. These tapered edges 68a, 68b allow the tip 64 to deflect (move) over the protrusions 52, 53, when the tab 28 (and thus, the tip 64) is moved (slid) with manual force (in the direction of arrow Q), and engage the requisite protrusion 52, 53. This engagement is such that it will be maintained, whereby the bolt 30 remains in the extended (second) position until the spring member 60 is moved by manual force (in the direction of arrow R). For example, this engagement can be such that an external force of approximately 1-2 pounds in the directions of either arrows Q or R, when applied to the tab 28, causes the tip 64 to deflect over the protrusions 52, 53, allowing for the bolt 30 to move from this position.

The arm 62 of the spring member 60, typically connects to a neck portion 70, that connects to the tab 28. The spring member 60, neck portion 70 and tab 28, are typically a single integral member 74. The neck portion 70 includes a tongue 75, that extends beyond the opening 48 in the bolt 30, and serves as a stop surface for the integral member 74 (when the bolt 30 is moved to the extended position, in the direction of arrow Q). There is also a bore 76 extending through the integral member 74. This single integral member 74 is typically of a resilient and low friction material, typically a polymeric material or plastic, for example, acetyl. It is typically formed by techniques such as injection molding and the like. The integral nature of the member 74 coupled with the material provides the spring member 60 with spring-like or flexible behavior.

Alternately, the arm 62 and tip 64 of the spring member 60, or only the arm 62 of the spring member 60 can be made of metal, such as spring steel. The metal portion could be integrally molded to the neck portion 70 and tab 28, and where applicable, the tip 64 (where the tip 64 is of a polymeric material). Alternately, the arm 62 and tip 64 of the spring member 60, or only the arm 62 of the spring member 60 (with tip 64 attached thereto) can be separate pieces from the neck portion 70 and tab 28.

A trailer 80 fits into a groove 82 in the neck portion 70. The trailer 80 is typically formed of a platform 84 having a bore 86 therein with outwardly angled lateral 88, and intermediate 89 edges. These lateral 88 and intermediate edges 89 are angled to correspond with the angling of the edges 42 of the bolt 30, so as to fit within the V-like shaped contour of the bolt 30 (FIG. 3). This arrangement facilitates easy assembly of the aforementioned components.

A lip 90 protrudes from the intermediate edge 89. This lip 90 is such that it contacts or rides just slightly above the surface 56 of the second side 47, but will abut the head S1′ of the screw S1, limiting travel of the bolt 30 in the direction of arrow R.

The trailer 80 is typically an integral member. It is typically made as a molded piece of the materials described for the member 74 above.

The integral member 74 and trailer 80 are typically joined to the bolt 30 by a pop-rivet 94 or the like. This pop rivet 94 extends through the bores 76 and 86, in the integral member 74 and trailer 80 respectively, as well as the opening 48 in the bolt 30.

The protrusions 52, 53 are typically positioned such that, for example, 1) the tip 64 of the arm 62 of the spring member 60 will be confined between the screw S1 and the first protrusion 52, for retaining the bolt 30 in the retracted or first position; or 2) such that the tip 64 of the spring member 60 extends beyond the second protrusion 53 (in the direction of arrow Q), such that the tab 28 abuts the closed end 27 of the slot 24, with the bolt 30 now in the extended or second position. The tip 64 may be of other configurations, provided it can be deflected (moved) over the protrusions 52, 53 yet engage the protrusions 52, 53, with forces sufficient that these engagements will be broken only upon manual movement of the bolt 30 through the forces applied to the tab 28 in the direction of arrows Q and R respectively.

The housing 22 and bolt 30 are typically both unitary in construction, but could be formed from multiple pieces. The housing 22 is for example, made of aluminum, while the bolt 30 is, for example, made of stainless steel (i.e., heat treated 400 Stainless Steel).

The outside 96 (FIGS. 1A, 1B and 2) of the housing 22 is configured to include grooves 97 (FIGS. 1A, 1B and 2), so it can interlock within a door 100 or the like, in a correspondingly configured cut-out 102, as shown in FIGS. 7A and 7B.

In alternate embodiments of the flush bolt 20, the end 26 may also be closed like the already closed end 27. Here, corresponding openings 50 and 51 for screws would be rearranged to accommodate this configuration.

While the flush bolt 20 is shown in use with doors, such as French doors, this is exemplary only. The flush bolt 20 can also be used with drawers, cabinets and other movable structures where locking or retention in place is desired.

An exemplary operation of the latching device or flush bolt 20 will now be described, with reference to FIGS. 1-7B. When the flush bolt 20 is installed in a door structure and initially in the retracted position, as shown in FIGS. 1A, 2 and 7A, when locking is desired, the user aligns the flush bolt 20 with a retaining structure, for example, an opening, a ring, a tube or the like, and with manual force, slides the tab 28 in the direction of arrow Q. Sliding continues until the tip (flange) 64 passes over the second protrusion 53, and the tab 28 abuts the closed end 27 of the slot 28. The bolt 30 is now in its fully extended position, outside of the housing 22 (FIGS. 1B and 7B) and if in the retaining structure, will lock the door 100 or the like, to which the flush bolt 20 is attached, retaining the door 100 or the like in a constant position.

To move the door 100 or the like, the bolt 30 must be linearly retracted to remove it from the retaining structure. This is accomplished as a user manually moves (slides) the tab 28 in the direction of the arrow R. Sliding continues until the tip 64 of the spring member 60 has moved beyond the first protrusion 52 and the lip 90 of the trailer 80 abuts the head S1′ of the screw S1, such that the spring member 60 and trailer 80 guide are confined between the screw S1 and the first protrusion 52. The bolt 30 has now been slid (in the direction of the arrow R) completely out of the retaining structure and is fully within the housing 22 (FIGS. 1A, 2 and 7A).

There has been shown and described at least one preferred embodiment of a bolt latching device. It is apparent to those skilled in the art, however, that many changes, variations, modifications, and other uses and applications for the latching device and its components are possible, and also such changes, variations, modifications, and other uses and applications which do not depart from the spirit and scope of the invention are deemed to be covered by the invention, which is limited only by the claims which follow.

What is claimed is:

1. A latching device comprising:
a housing including at least one detent;
a bolt configured for sliding at least partially within said housing between a retracted position and an extended position, where said bolt extends beyond said housing;
a spring member in communication with said bolt, said spring member configured for at least partially retaining said bolt in a frictionally snug and slideable engagement within said housing and including a portion configured for engaging said at least one detent of said housing to retain said bolt in said extended position.

2. The latching device of claim 1, wherein said at least one detent includes at least two detents and said detents include protrusions extending from said housing.

3. The latching device of claim 1, additionally comprising:
a trailer in communication with said spring member, said trailer configured for at least partially retaining said bolt in a frictionally snug and slideable engagement within said housing and limiting travel of said bolt.

4. The latching device of claim 3, wherein said trailer includes a lip for at least partially retaining said bolt in a frictionally snug and slideable engagement within said housing and limiting travel of said bolt.

5. The latching device of claim 1, wherein said spring member includes a an arm configured for exhibiting spring-like behavior, said arm including a tip, said tip defining said portion of said spring member configured for engaging said at least one detent of said housing to retain said bolt in said extended position.

6. The latching device of claim 1, wherein said housing includes oppositely disposed grooves extending therethrough and said bolt includes lateral portions with edges for receipt in said respective grooves.

7. The latching device of claim 1, additionally comprising:
a tab, said tab in communication with said bolt; and
said housing including a slot for receiving at least a portion of said tab.

8. The latching device of claim 1, wherein said housing envelopes said bolt.

9. The latching device of claim 8, wherein said housing includes an outer surface configured for fitting in a correspondingly shaped track in a structure.

10. A latching device comprising:
a housing including at least one detent;
a bolt configured for sliding at least partially within said housing between a retracted position and an extended position, where said bolt extends beyond said housing;
a spring member in communication with said bolt, said spring member configured for at least partially retaining said bolt in a frictionally snug and slideable engagement within said housing and limiting travel of said bolt by engaging said at least one detent; and
said housing at least partially enveloping said bolt.

11. The latching device of claim 10, wherein said spring member includes a portion configured for engaging said at least one detent of said housing to retain said bolt in said extended position

12. The latching device of claim 11, wherein said at least one detent includes at least two detents and said detents include protrusions extending from said housing.

13. The latching device of claim 10, additionally comprising:
a trailer in communication with said spring member, said trailer configured for at least partially retaining said bolt in a frictionally snug and slideable engagement within said housing and limiting travel of said bolt.

14. The latching device of claim 13, wherein said trailer includes a lip for at least partially retaining said bolt in a frictionally snug and slideable engagement within said housing and limiting travel of said bolt.

15. The latching device of claim 10, wherein said spring member includes a an arm configured for exhibiting spring-like behavior, said arm including a tip, said tip defining said portion of said spring member configured for engaging said at least one detent of said housing to retain said bolt in said extended position.

16. The latching device of claim 10, wherein said housing includes oppositely disposed grooves extending therethrough and said bolt includes lateral portions with edges for receipt in said respective grooves.

17. The latching device of claim 10, additionally comprising:
a tab, said tab in communication with said bolt; and
said housing including a slot for receiving at least a portion of said tab.

18. The latching device of claim 10, wherein said housing includes an outer surface configured for fitting in a correspondingly shaped track in a structure.
